(19) United States
(12) Patent Application Publication
(10) Pub. No.: US 2007/0041709 A1
(43) Pub. Date: Feb. 22, 2007

(54) Recording medium, method and apparatus for reproducing data, and method and apparatus for recording data

(75) Inventor: Kun Suk Kim, Anyang-si (KR)

Correspondence Address: HARNESS, DICKEY & PIERCE, P.L.C., P.O. BOX 8910, RESTON, VA, 20195, US

(73) Assignee: LG Electronics Inc.

(21) Appl. No.: 11/506,869

(22) Filed: Aug. 21, 2006

Related U.S. Application Data
(60) Provisional application No. 60/709,807, filed on Aug. 22, 2005.

(30) Foreign Application Priority Data
Apr. 3, 2006 (KR) 10-2006-0030107

(51) Int. Cl. H04N 7/00

(52) U.S. Cl. 386/95

(57) ABSTRACT

In one embodiment, management data is read from a recording medium, and a secondary video stream is selectively displayed with a primary video stream based on the management data. The secondary video stream represents the picture-in-picture presentation path with respect to a primary presentation path represented by the primary video stream. Even if the secondary video stream is not displayed, the secondary video stream is decoded.

### DOMESTIC PRIORITY INFORMATION

This application claims the benefit of the U.S. Provisional Application No. 60/709,807 filed Aug. 22, 2005, which is hereby incorporated by reference in their entirety.

### FOREIGN PRIORITY INFORMATION

This application claims the benefit of the Korean Patent Application No. 10-2006-0030107, filed on Apr. 3, 2006, which is hereby incorporated by reference in its entirety.

### BACKGROUND OF THE INVENTION

1. Field of the Invention

The present invention relates to recording and reproducing methods and apparatuses, and a recording medium.

2. Discussion of the Related Art

Optical discs are widely used as a recording medium capable of recording a large amount of data therein. Particularly, high-density optical recording mediums such as a Blu-ray Disc (BD) and a high definition digital versatile disc (HD-DVD) have recently been developed, and are capable of recording and storing large amounts of high-quality video data and high-quality audio data.

Such a high-density optical recording medium, which is based on next-generation recording medium techniques, is considered to be a next-generation optical recording solution capable of storing much more data than conventional DVDs. Development of high-density optical recording mediums is being conducted, together with other digital appliances. Also, an optical recording/reproducing apparatus, to which the standard for high density recording mediums is applied, is under development.

In accordance with the development of high-density recording mediums and optical recording/reproducing apparatuses, it is possible to simultaneously reproduce a plurality of videos. However, there is known no method capable of effectively simultaneously recording or reproducing a plurality of videos. Furthermore, it is difficult to develop a complete optical recording/reproducing apparatus based on high-density recording mediums because there is no completely-established standard for high-density recording mediums.

### SUMMARY OF THE INVENTION

The present invention relates to a method of managing reproduction of at least one picture-in-picture presentation path.

In one embodiment, management data is read from a recording medium, and a secondary video stream is selectively displayed with a primary video stream based on the management data. The secondary video stream represents the picture-in-picture presentation path with respect to a primary presentation path represented by the primary video stream. Even if the secondary video stream is not displayed, the secondary video stream is decoded.

In one embodiment, the management data includes display information indicating whether to close a window in which the secondary video stream is to be displayed, and the secondary video stream is displayed based on the display information.

In another embodiment, the display information indicates whether to close the window in which the secondary video stream is to be displayed during trick play of the primary video stream.

In a further embodiment, the selective display of the secondary video stream based on the display information only takes place if the secondary video stream is being reproduced synchronously with the primary video stream.

The present invention further relates to an apparatus for managing reproduction of at least one picture-in-picture presentation path.

In one embodiment of the apparatus, a driver is configured to drive a reproducing element for reproducing data from a recording medium, and a controller configured to control the driver to read management data from the recording medium. The controller is configured to selectively display a secondary video stream with a primary video stream based on the management data. The secondary video stream represents the picture-in-picture presentation path with respect to a primary presentation path represented by the primary video stream. A decoder in the apparatus is configured to decode the secondary video stream even if the controller does not display the secondary video stream.

In one embodiment, the management data includes display information indicating whether to close a window in which the secondary video stream is to be displayed, and the controller is configured to selectively display the secondary video stream based on the display information.

In another embodiment, the display information indicates whether to close the window in which the secondary video stream is to be displayed during trick play of the primary video stream.

In yet another embodiment, the controller is configured to selectively display the secondary video stream based on the display information only if the secondary video stream is being reproduced synchronously with the primary video stream.

A further embodiment of the present invention relates to a recording medium having a data structure for managing reproduction of at least one picture-in-picture presentation path.

In one embodiment, the recording medium includes a data area and a management area. The data area stores a primary video stream. The primary video stream represents a primary presentation path. The management area stores management data for managing reproduction of a picture-in-picture presentation path with respect to the primary presentation path. The management data includes display information indicating whether to close a window in which a secondary video stream is to be displayed, and the secondary video stream represents the picture-in-picture presentation path.

For example, the display information indicates whether to close the window in which the secondary video stream is to be displayed during trick play of the primary video stream.

The present invention also relates to a method and apparatus for recording the data structure for managing reproduction of at least one picture-in-picture presentation path on a recording medium.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principles of the invention. In the drawings:

FIG. 1 is a schematic view illustrating an exemplary embodiment of the combined use of an optical recording/reproducing apparatus according to an embodiment of the present invention and a peripheral appliance;

FIG. 2 is a schematic diagram illustrating a structure of files recorded in an optical disc as a recording medium according to an embodiment of the present invention;

FIG. 3 is a schematic diagram illustrating a data recording structure of the optical disc as the recording medium according to an embodiment of the present invention;

FIG. 4 is a schematic diagram for understanding a concept of a secondary video according to an embodiment of the present invention;

FIG. 5 is a block diagram illustrating an overall configuration of an optical recording/reproducing apparatus according to an embodiment of the present invention;

FIG. 6 is a schematic diagram explaining a playback system according to an embodiment of the present invention;

FIG. 7 is a schematic diagram illustrating an exemplary embodiment of secondary video metadata according to the present invention;

FIGS. 8A to 8C are schematic diagrams for understanding of the secondary video sub path types according to embodiments of the present invention, respectively;

FIG. 9 is a block diagram schematically illustrating an AV decoder model according to an embodiment of the present invention;

FIGS. 10A-10C are schematic diagrams for understanding of secondary video timeline types according to embodiments of the present invention; and

FIG. 11 is a flow chart illustrating an exemplary embodiment of a data reproducing method according to the present invention.

### DETAILED DESCRIPTION OF EXAMPLE EMBODIMENTS

Reference will now be made in detail to example embodiments of the present invention, which are illustrated in the accompanying drawings. Wherever possible, the same reference numbers will be used throughout the drawings to refer to the same or like parts.

In the following description, example embodiments of the present invention will be described in conjunction with an optical disc as an example recording medium. In particular, a Blu-ray disc (BD) is used as an example recording medium, for the convenience of description. However, it will be appreciated that the technical idea of the present invention is applicable to other recording mediums, for example, HD-DVD, equivalently to the BD.

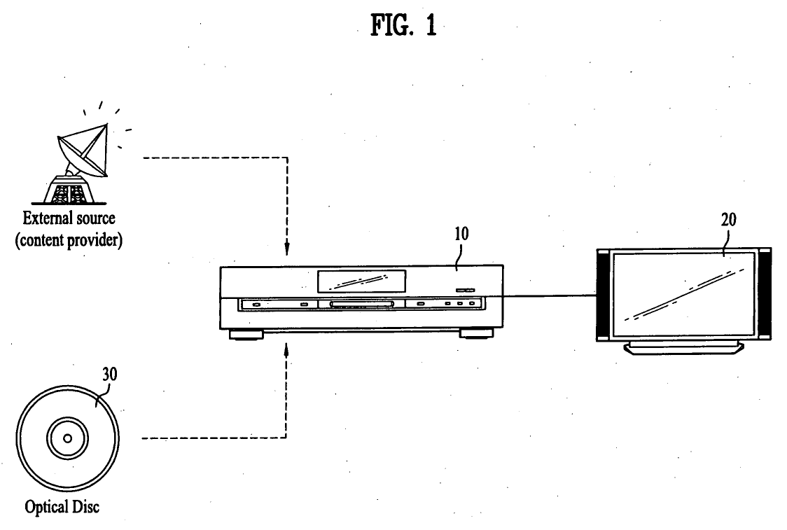

“Storage” as generally used in the embodiments is a storage equipped in a optical recording/reproducing apparatus (FIG. 1). The storage is an element in which the user freely stores required information and data, to subsequently use the information and data. For storages, which are generally used, there are a hard disk, a system memory, a flash memory, and the like. However, the present invention is not limited to such storages.

In association with the present invention, the “storage” is also usable as means for storing data associated with a recording medium (for example, a BD). Generally, the data stored in the storage in association with the recording medium is externally-downloaded data.

As for such data, it will be appreciated that partially-allowed data directly read out from the recording medium, or system data produced in association with recording and production of the recording medium (for example, metadata) can be stored in the storage.

For the convenience of description, in the following description, the data recorded in the recording medium will be referred to as “original data”, whereas the data stored in the storage in association with the recording medium will be referred to as “additional data”.

Also, “title” defined in the present invention means a reproduction unit interfaced with the user. Titles are linked with particular objects, respectively. Accordingly, streams recorded in a disc in association with a title are reproduced in accordance with a command or program in an object linked with the title. In particular, for the convenience of description, in the following description, among the titles including video data according to an MPEG compression scheme, titles supporting features such as seamless multi-angle and multi story, language credits, director's cuts, trilogy collections, etc. will be referred to as “High Definition Movie (HDMV) titles”. Also, among the titles including video data according to an MPEG compression scheme, titles providing a fully programmable application environment with network connectivity thereby enabling the content provider to create high interactivity will be referred to as “BD-J titles”.

FIG. 1 illustrates an exemplary embodiment of the combined use of an optical recording/reproducing apparatus according to the present invention and a peripheral appliance.

The optical recording/reproducing apparatus 10 according to an embodiment of the present invention can record or reproduce data in/from various optical discs having different formats. If necessary, the optical recording/reproducing apparatus 10 may be designed to have recording and reproducing functions only for optical discs of a particular format (for example, BD), or to have a reproducing function alone, except for a recording function. In the following description, however, the optical recording/reproducing apparatus 10 will be described in conjunction with, for example, a BD-player for playback of a BD, or a BD-recorder for recording and playback of a BD, taking into consideration the compatibility of BDs with peripheral appliances, which must be solved in the present invention. It will be appreciated that the optical recording/reproducing apparatus 10 of the present invention may be a drive which can be built in a computer or the like.

The optical recording/reproducing apparatus 10 of the present invention not only has a function for recording and playback of an optical disc 30, but also has a function for receiving an external input signal, processing the received signal, and sending the processed signal to the user in the form of a visible image through an external display 20. Although there is no particular limitation on external input signals, representative external input signals may be digital multimedia broadcasting-based signals, Internet-based signals, etc. Specifically, as to Internet-based signals, desired data on the Internet can be used after being downloaded through the optical recording/reproducing apparatus 10 because the Internet is a medium easily accessible by any person.

In the following description, persons who provide contents as external sources will be collectively referred to as a “content provider (CP)”.

“Content” as used in the present invention may be the content of a title, and in this case means data provided by the author of the associated recording medium.

Hereinafter, original data and additional data will be described in detail. For example, a multiplexed AV stream of a certain title may be recorded in an optical disc as original data of the optical disc. In this case, an audio stream (for example, Korean audio stream) different from the audio stream of the original data (for example, English) may be provided as additional data via the Internet. Some users may desire to download the audio stream (for example, Korean audio stream) corresponding to the additional data from the Internet, to reproduce the downloaded audio stream along with the AV stream corresponding to the original data, or to reproduce the additional data alone. To this end, it is desirable to provide a systematic method capable of determining the relation between the original data and the additional data, and performing management/reproduction of the original data and additional data, based on the results of the determination, at the request of the user.

As described above, for the convenience of description, signals recorded in a disc have been referred to as “original data”, and signals present outside the disc have been referred to as “additional data”. However, the definition of the original data and additional data is only to classify data usable in the present invention in accordance with data acquisition methods. Accordingly, the original data and additional data should not be limited to particular data. Data of any attribute may be used as additional data as long as the data is present outside an optical disc recorded with original data, and has a relation with the original data.

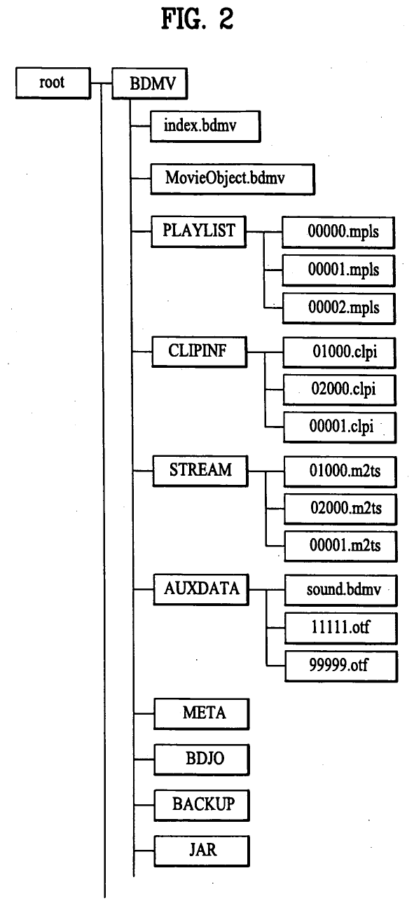

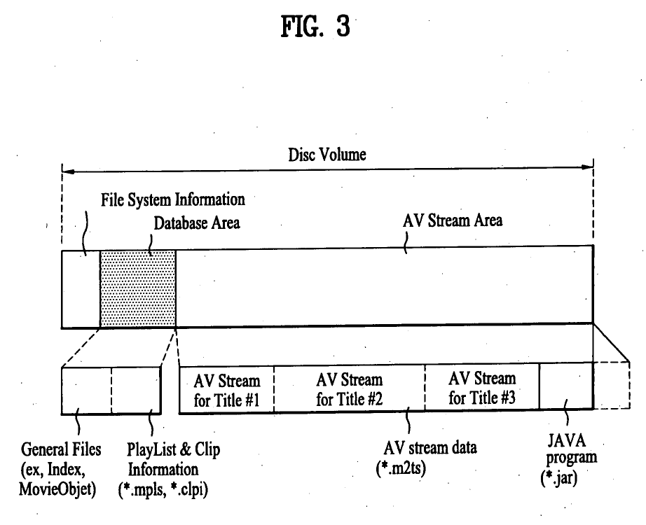

In order to accomplish the request of the user, the original data and additional data must have file structures having a relation therebetween, respectively. Hereinafter, file structures and data recording structures usable in a BD will be described with reference to FIGS. 2 and 3.

FIG. 2 illustrates a file structure for reproduction and management of original data recorded in a BD in accordance with an embodiment of the present invention.

The file structure of the present invention includes a root directory, and at least one BDMV directory BDMV present under the root directory. In the BDMV directory BDMV, there are an index file “index.bdmv” and an object file “MovieObject.bdmv” as general files (upper files) having information for securing an interactivity with the user. The file structure of the present invention also includes directories having information as to the data actually recorded in the disc, and information as to a method for reproducing the recorded data, namely, a playlist directory PLAYLIST, a clip information directory CLIPINF, a stream directory STREAM, an auxiliary directory AUXDATA, a BD-J directory BDJO, a metadata directory META, a backup directory BACKUP, and a JAR directory. Hereinafter, the above-described directories and files included in the directories will be described in detail.

The JAR directory includes JAVA program files.

The metadata directory META includes a file of data about data, namely, a metadata file. Such a metadata file may include a search file and a metadata file for a disc library. Such metadata files are used for efficient search and management of data during the recording and reproduction of data.

The BD-J directory BDJO includes a BD-J object file for reproduction of a BD-J title.

The auxiliary directory AUXDATA includes an additional data file for playback of the disc. For example, the auxiliary directory AUXDATA may include a “Sound.bdmv” file for providing sound data when an interactive graphics function is executed, and “11111.otf” and “99999.otf” files for providing font information during the playback of the disc.

The stream directory STREAM includes a plurality of files of AV streams recorded in the disc according to a particular format. Most generally, such streams are recorded in the form of MPEG-2-based transport packets. The stream directory STREAM uses “*.m2ts” as an extension name of stream files (for example, 01000.m2ts, 02000.m2ts, . . . ). Particularly, a multiplexed stream of video/audio/graphic information is referred to as an “AV stream”. A title is composed of at least one AV stream file.

The clip information (clip-info) directory CLIPINF includes clip-info files 01000.clpi, 02000.clpi, . . . respectively corresponding to the stream files “*.m2ts” included in the stream directory STREAM. Particularly, the clip-info files “*.clpi” are recorded with attribute information and timing information of the stream files “*.m2ts”. Each clip-info file “*.clpi” and the stream file “*.m2ts” corresponding to the clip-info file “*.clpi” are collectively referred to as a “clip”. That is, a clip is indicative of data including both one stream file “*.m2ts” and one clip-info file “*.clpi” corresponding to the stream file “*.m2ts”.

The playlist directory PLAYLIST includes a plurality of playlist files “*.mpls”. “Playlist” means a combination of playing intervals of clips. Each playing interval is referred to as a “playitem”. Each playlist file “*.mpls” includes at least one playitem, and may include at least one subplayitem. Each of the playitems and subplayitems includes information as to the reproduction start time IN-Time and reproduction end time OUT-Time of a particular clip to be reproduced. Accordingly, a playlist may be a combination of playitems.

As to the playlist files, a process for reproducing data using at least one playitem in a playlist file is defined as a “main path”, and a process for reproducing data using one subplayitem is defined as a “sub path”. The main path provides master presentation of the associated playlist, and the sub path provides auxiliary presentation associated with the master presentation. Each playlist file should include one main path. Each playlist file also includes at least one sub path, the number of which is determined depending on the presence or absence of subplayitems. Thus, each playlist file is a basic reproduction/management file unit in the overall reproduction/management file structure for reproduction of a desired clip or clips based on a combination of one or more playitems.

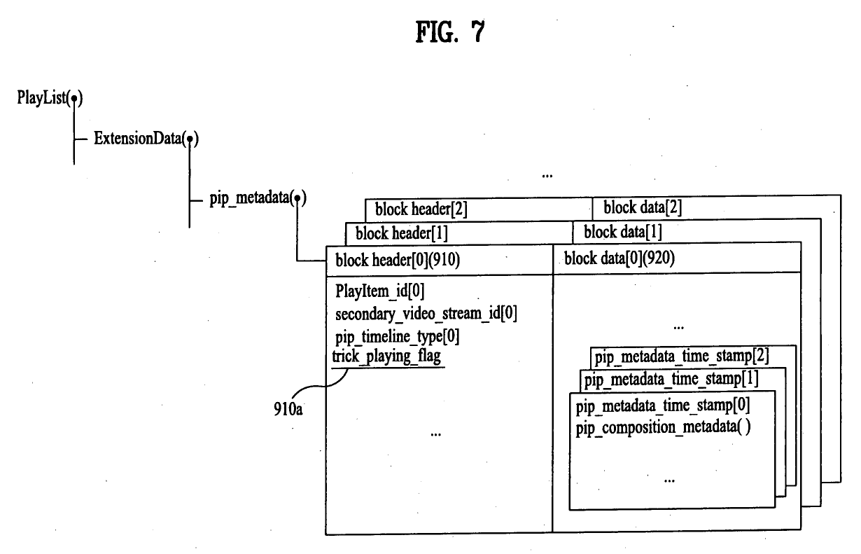

In association with the present invention, video data, which is reproduced through a main path, is referred to as a primary video, whereas video data, which is reproduced through a sub path, is referred to as a secondary video. The function of the optical recording/reproducing apparatus for simultaneously reproducing primary and secondary videos is also referred to as a “picture-in-picture (PiP)”. In association with this, how the secondary video should be processed if the primary video is forwardly or backwardly reproduced at a reproduction speed other than a normal reproduction speed, namely, in a trick playing mode of the primary video, will be addressed below. Embodiments of the present invention provide a secondary video reproduction method efficiently usable in the trick playing mode of the primary video. This will be described in detail with reference to FIG. 7 and the following drawings.

The backup directory BACKUP stores a copy of the files in the above-described file structure, in particular, copies of files recorded with information associated with playback of the disc, for example, a copy of the index file “index.bdmv”, object files “MovieObject.bdmv” and “BD-JObject.bdmv”, unit key files, all playlist files “*.mpls” in the playlist directory PLAYLIST, and all clip-info files “*.clpi” in the clip-info directory CLIPINF. The backup directory BACKUP is adapted to separately store a copy of files for backup purposes, taking into consideration the fact that, when any of the above-described files is damaged or lost, fatal errors may be generated in association with playback of the disc.

Meanwhile, it will be appreciated that the file structure of the present invention is not limited to the above-described names and locations. That is, the above-described directories and files should not be understood through the names and locations thereof, but should be understood through the meaning thereof.

FIG. 3 illustrates a data recording structure of the optical disc according to an embodiment of the present invention. In FIG. 3, recorded structures of information associated with the file structures in the disc are illustrated. Referring to FIG. 3, it can be seen that the disc includes a file system information area recorded with system information for managing the overall file, an area recorded with the index file, object file, playlist files, clip-info files, and meta files (which are required for reproduction of recorded streams “*.m2ts”), a stream area recorded with streams each composed of audio/video/graphic data or STREAM files, and a JAR area recorded with JAVA program files. The areas are arranged in the above-descried order when viewing from the inner periphery of the disc.

Stream data of a primary video and/or a secondary video is stored in the stream area. The secondary video may be multiplexed in the same stream as the primary video, or may be multiplexed in a stream different from that of the primary video.

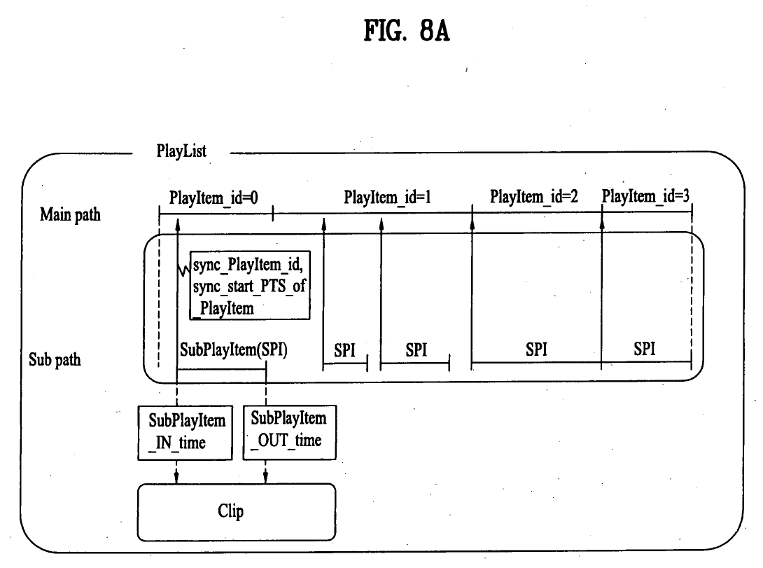

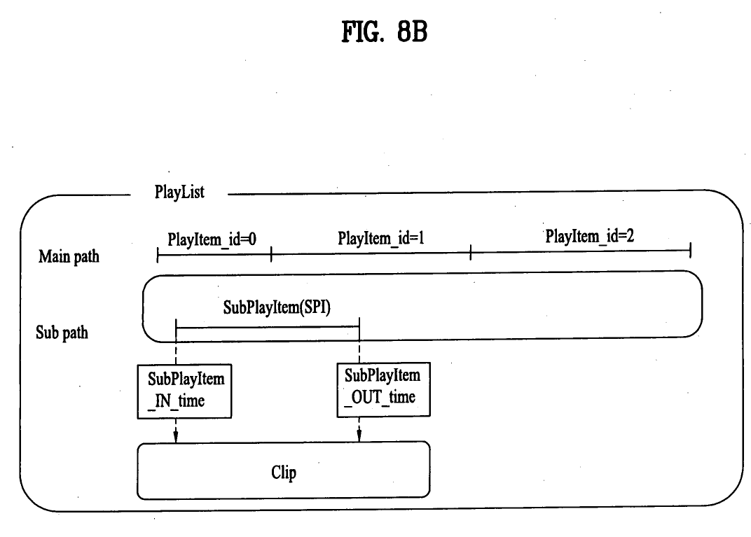

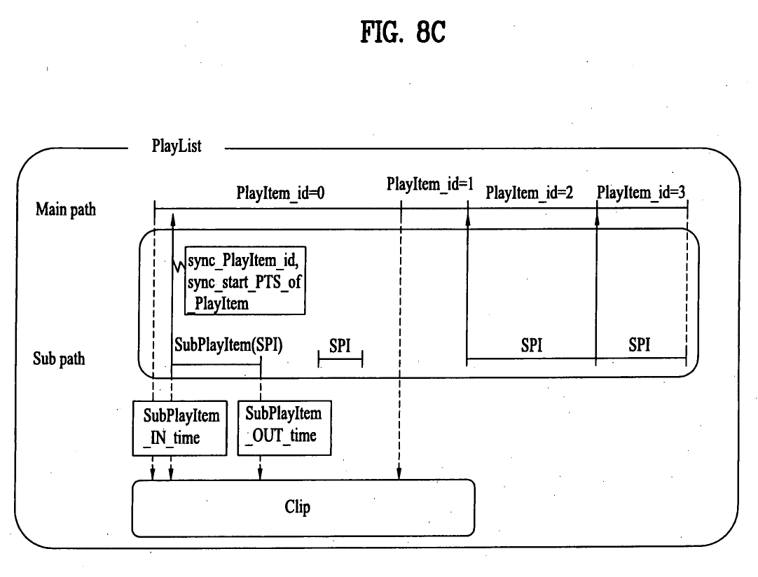

In the disc, there is an area for recording file information for reproduction of contents in the stream area. This area is referred to as a “management area”. The file system information area and database area are included in the management area. In accordance with the present invention, a sub path is used to reproduce the secondary video. The type of the sub path may be classified into three types in accordance with the kind of stream in which the secondary video is multiplexed, and whether or not the sub path is synchronous with a main path. The three sub path types will be described with reference to FIGS. 8A to 8C. Since the method for reproducing the secondary video is varied depending on the sub path type, the management area includes information indicating the sub path type. Meanwhile, in accordance with an embodiment of the present invention, a flag associated with reproduction of the secondary video in the trick playing mode of the primary video is stored in the management area. The flag is included in metadata for managing reproduction of the secondary video.

The areas of FIG. 3 are shown and described only for illustrative purposes. It will be appreciated that the present invention is not limited to the area arrangement of FIG. 3.

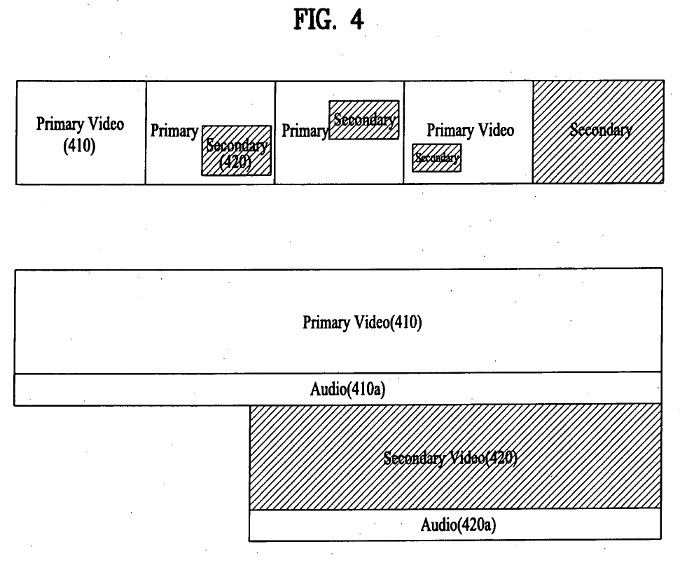

FIG. 4 is a schematic diagram for understanding of the concept of the secondary video according to embodiments of the present invention.

The present invention provides a method for reproducing secondary video data, simultaneously with primary video data. For example, the present invention provides an optical recording/reproducing apparatus that enables a PiP application, and, in particular, effectively performs the PiP application.

During reproduction of a primary video 410 as shown in FIG. 4, it may be necessary to output other video data associated with the primary video 410 through the same display 20 as that of the primary video 410. In accordance with the present invention, such a PiP application can be achieved. For example, during playback of a movie or documentary, it is possible to provide, to the user, the comments of the director or episode associated with the shooting procedure. In this case, the video of the comments or episode is a secondary video 420. The secondary video 420 can be reproduced with the primary video 410, from the beginning of the reproduction of the primary video 410.

The reproduction of the secondary video 420 may be begun at an intermediate time of the reproduction of the primary video 410. It is also possible to display the secondary video 420 while varying the position or size of the secondary video 420 on the screen, depending on the reproduction procedure. A plurality of secondary videos 420 may also be implemented. In this case, the secondary videos 420 may be reproduced, separately from one another, during the reproduction of the primary video 410. The primary video 410 can be reproduced along with an audio 410a associated with the primary video 410. Similarly, the secondary video 420 can be reproduced along with an audio 420a associated with the secondary video 420.

In connection with this, as described below, an embodiment of the present invention provides for determining how the secondary video 420 should be processed if the primary video 410 is reproduced at a reproduction speed other than a normal reproduction speed, namely, if the primary video 410 is in a trick playing mode. That is, an embodiment of the present invention provides for defining whether or not the reproduction of the secondary video 420 is continued through the sub path, irrespective of the trick playing of the primary video 410, namely, whether the window, to which the secondary video 420 is output, is maintained in an open state, or should be closed.

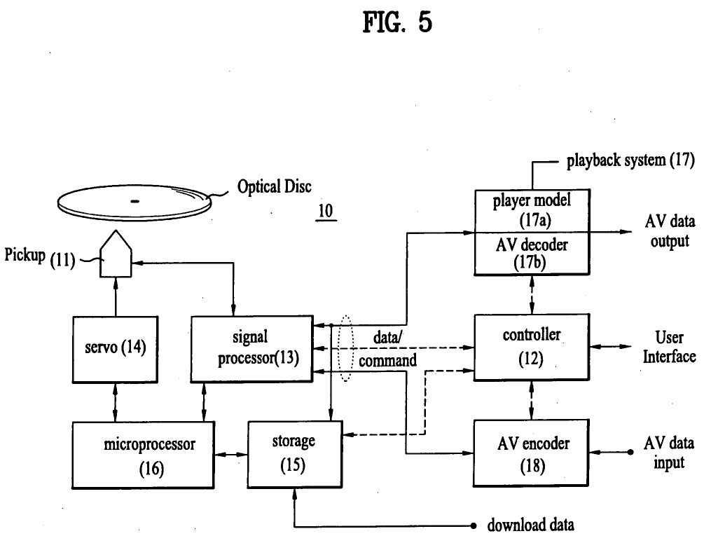

FIG. 5 illustrates an exemplary embodiment of the overall configuration of the optical recording/reproducing apparatus 10 according to the present invention.

As shown in FIG. 5, the optical recording/reproducing apparatus 10 mainly includes a pickup 11, a servo 14, a signal processor 13, and a microprocessor 16. The pickup 11 reproduces original data and management data recorded in an optical disc. The management data includes reproduction management file information. The servo 14 controls operation of the pickup 11. The signal processor 13 receives a reproduced signal from the pickup 11, and restores the received reproduced signal to a desired signal value. The signal processor 13 also modulates signals to be recorded, for example, primary and secondary videos, to signals recordable in the optical disc, respectively. The microprocessor 16 controls the operations of the pickup 11, the servo 14, and the signal processor 13. The pickup 11, the servo 14, the signal processor 13, and the microprocessor 16 are also collectively referred to as a “recording/reproducing unit”. In accordance with the present invention, the recording/reproducing unit reads data from an optical disc 30 or storage 15 under the control of a controller 12, and sends the read data to an AV decoder 17b. That is, in a viewpoint of reproduction, the recording/reproducing unit functions as a reader unit for reading data. The recording/reproducing unit also receives an encoded signal from an AV encoder 18, and records the received signal in the optical disc 30. Thus, the recording/reproducing unit can record video and audio data in the optical disc 30.

The controller 12 downloads additional data present outside the optical disc 30 in accordance with a user command, and stores the additional data in the storage 15. The controller 12 also reproduces the additional data stored in the storage 15 and/or the original data in the optical disc 30 at the request of the user. In accordance with the present invention, the controller 12 generates information as to trick playing of the secondary video, and performs a control operation for recording the information in the optical disc 30, along with video data. The information may be recorded in the optical disc 30, and more particularly, may be included in metadata for managing reproduction of the secondary video.

The optical recording/reproducing apparatus 10 further includes a playback system 17 for decoding data, and providing the decoded data to the user under the control of the controller 12. The playback system 17 includes an AV decoder 17b for decoding an AV signal. The playback system 17 also includes a player model 17a for analyzing an object command or application associated with playback of a particular title, and a user command input via the controller 12, and determining a playback direction, based on the results of the analysis. In an embodiment, the player model 17a may be implemented as including the AV decoder 17b. In this case, the playback system 17 is the player model itself. The AV decoder 17b may include a plurality of decoders respectively associated with different kinds of signals.

The AV encoder 18, which is also included in the optical recording/reproducing apparatus 10 of the present invention, converts an input signal to a signal of a particular format, for example, an MPEG2 transport stream, and sends the converted signal to the signal processor 13, to enable recording of the input signal in the optical disc 30.

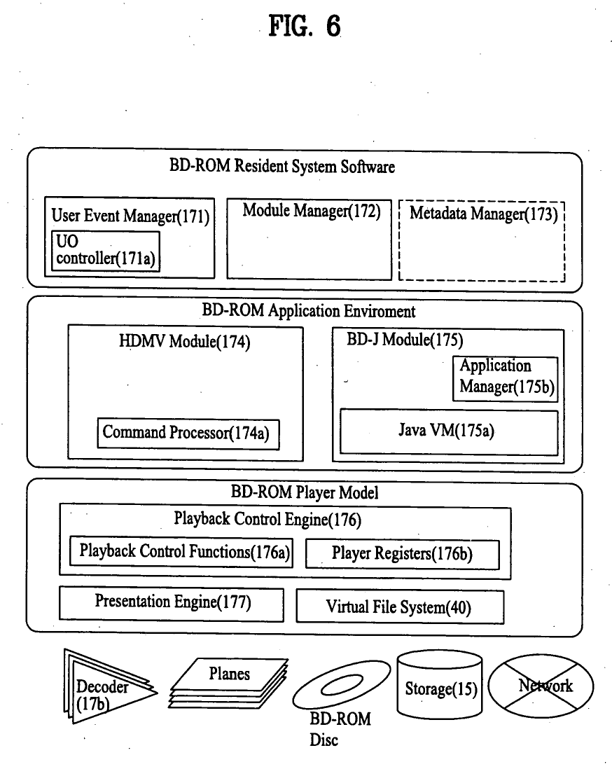

FIG. 6 is a schematic diagram explaining the playback system according to an embodiment of the present invention. In accordance with the present invention, the playback system can simultaneously reproduce the primary and secondary videos.

“Playback system” means a collective reproduction processing means which is configured by programs (software) and/or hardware provided in the optical recording/reproducing apparatus. That is, the playback system is a system which can not only play back a recording medium loaded in the optical recording/reproducing apparatus, but also can reproduce and manage data stored in the storage of the apparatus in association with the recording medium (for example, after being downloaded from the outside of the recording medium).

In particular, as shown in FIG. 6, the playback system 17 may include a user event manager 171, a module manager 172, a metadata manager 173, an HDMV module 174, a BD-J module 175, a playback control engine 176, a presentation engine 177, and a virtual file system 40. This configuration will be described in detail, hereinafter.

As a separate reproduction processing/managing means for reproduction of HDMV titles and BD-J titles, the HDMV module 174 for HDMV titles and the BD-J module 175 for BD-J titles are constructed independently of each other. Each of the HDMV module 174 and BD-J module 175 has a control function for receiving a command or program contained in the associated object “Movie Object” or “BD-J Object”, and processing the received command or program. Each of the HDMV module 174 and BD-J module 175 can separate an associated command or application from the hardware configuration of the playback system, to enable portability of the command or application. For reception and processing of the command, the HDMV module 174 includes a command processor 174a. For reception and processing of the application, the BD-J module 175 includes a Java Virtual Machine (VM) 175a, and an application manager 175b.

The Java VM 175a is a virtual machine in which an application is executed. The application manager 175b includes an application management function for managing the life cycle of an application processed in the BD-J module 175.

The module manager 172 functions not only to send user commands to the HDMV module 174 and BD-J module 175, respectively, but also to control operations of the HDMV module 174 and BD-J module 175. A playback control engine 176 analyzes the playlist file actually recorded in the disc in accordance with a playback command from the HDMV module 174 or BD-J module 175, and performs a playback function based on the results of the analysis. The presentation engine 177 decodes a particular stream managed in association with reproduction thereof by the playback control engine 176, and displays the decoded stream in a displayed picture. In particular, the playback control engine 176 includes playback control functions 176a for managing all playback operations, and player registers 176b for storing information as to the playback status and playback environment of the player (information of player status registers (PSRs) and general purpose registers (GPRs)). In some cases, the playback control functions 176a mean the playback control engine 176 itself.

The HDMV module 174 and BD-J module 175 receive user commands in independent manners, respectively. The user command processing methods of HDMV module 174 and BD-J module 175 are also independent of each other. In order to transfer a user command to an associated one of the HDMV module 174 and BD-J module 175, a separate transfer means should be used. In accordance with the present invention, this function is carried out by the user event manager 171. Accordingly, when the user event manager 171 receives a user command generated through a user operation (UO) controller 171a, the user event manager sends the received user command to the module manager 172 or UO controller 171a. On the other hand, when the user event manager 171 receives a user command generated through a key event, the user event manager sends the received user command to the Java VM 175a in the BD-J module 175.

The playback system 17 of the present invention may also include a metadata manager 173. The metadata manager 173 provides, to the user, a disc library and an enhanced search metadata application. The metadata manager 173 can perform selection of a title under the control of the user. The metadata manager 173 can also provide, to the user, recording medium and title metadata.

The module manager 172, HDMV module 174, BD-J module 175, and playback control engine 176 of the playback system according to the present invention can perform desired processing in a software manner. Practically, the processing using software is advantageous in terms of design, as compared to processing using a hardware configuration. Of course, it is general that the presentation engine 177, decoder 19, and planes are designed using hardware. In particular, the constituent elements (for example, constituent elements designated by reference numerals 172, 174, 175, and 176), each of which performs desired processing using software, may constitute a part of the controller 12. Therefore, it should be noted that the above-described constituents and configuration of the present invention be understood on the basis of their meanings, and are not limited to their implementation methods such as hardware or software implementation.

Here, “plane” means a conceptual model for explaining overlaying procedures of the primary video, secondary video, PG (presentation graphics), IG (interactive graphics), text sub titles. In accordance with the present invention, the secondary video plane is arranged in front of the primary video plane. Accordingly, the secondary video output after being decoded is presented on the secondary video plane. The second video plane is also called a “window”. Hereinafter, the second video plane, to which the second video is output, is referred to as a “secondary video window”.

FIG. 7 illustrates an exemplary embodiment of the secondary video metadata according to the present invention.

In accordance with the present invention, reproduction of the secondary video is managed using metadata. The metadata includes information about the reproduction time, reproduction size, and reproduction position of the secondary video. Hereinafter, the management data will be described in conjunction with an example in which the management data is PiP metadata.

The PiP metadata may be included in a playlist which is a kind of a reproduction management file. FIG. 7 illustrates PiP metadata blocks included in an ‘ExtensionData’ block of a playlist managing reproduction of the primary video. The PiP metadata may include at least one block header ‘block_header[k]’ 910 and block data ‘block_data[k] 920. The number of the block header and block data is determined depending on the number of metadata block entries stored in PiP metadata. The block header 910 includes header information of the associated metadata block. The block data 920 includes data information of the associated metadata block. Although PiP metadata is described as being included in the playlist, in the embodiment of FIG. 7, it may be included in the headers of secondary video streams implementing PiP.

The block header 910 may include a field indicating playitem identifying information (hereinafter, referred to as ‘PlayItem_id[k]’), and a field indicating secondary video stream identifying information (hereinafter, referred to as ‘secondary_video_stream_id[k]’). The ‘PlayItem_id[k]’ is a value corresponding to a playitem including an STN table in which ‘secondary_video_stream_id’ entry referred to by ‘secondary_video_stream_id[k]’ is listed. The ‘PlayItem_id’ value is given in the playlist block of the playlist file. In the PiP metadata, the entries of ‘PlayItem_id’ in the PiP metadata are sorted in an ascending order of the ‘PlayItem_id’. The ‘secondary_video_stream_id[k]’ is used to identify a sub path, and a secondary video stream to which the associated block data 920 is applied. That is, it is possible to identify the stream entry corresponding to ‘secondary_video_stream_id[k]’, in the STN table of ‘PlayItem’ corresponding to ‘PlayItem_id[k]’. Since the stream entry is recorded with the value of the sub path identification information associated with the secondary video, the optical recording/reproducing apparatus 10 can identify the sub path, which is used to reproduce the secondary video, based on the recorded value. The playlist block includes a sub path block.

In accordance with an embodiment of the present invention, it is defined how the reproduction of the secondary video is carried out in a trick playing mode of the primary video. Meanwhile, the reproduction of the secondary video is varied depending on the type of the sub path used to reproduce the secondary video, and the type of timeline referred to by PiP metadata for managing the reproduction of the secondary video. This will be described in more detail after first describing the different sub path types.

FIGS. 8A to 8C are schematic diagrams for understanding of the sub path types according to the present invention. PiP application models according to embodiments of the present invention are mainly classified into three types based on the kind of a stream in which the secondary video is multiplexed, and whether or not the sub path used to reproduce the secondary video is synchronous with a main path associated with the sub path. Accordingly, the kind of the sub path used to reproduce the secondary video, namely, the sub path type, is determined, taking into consideration the above-described three models.

In a sub path type shown in FIG. 8A, the secondary video is encoded in a stream different from that of the primary video, and the sub path is synchronous with the main path. The case in which the secondary video is multiplexed in a stream different from that of the primary video, as described above, is referred to as an ‘out-of-mux’ type.

Referring to FIG. 8A, the playlist for managing the primary and secondary videos includes one main path used to reproduce the primary video, and one sub path used to reproduce the secondary video. The main path is configured by four playitems (‘PlayItem_id’=0, 1, 2, 3), whereas the sub path is configured by a plurality of subplayitems. The sub path is synchronous with the main path. In detail, the secondary video is synchronized with the main path, using an information field ‘sync-PlayItem_id’, which identifies a playitem associated with each subplayitem, and presentation time stamp information ‘sync_start_PTS_of_PlayItem’, which indicates a presentation time of the subplayitem in the playitem. That is, when the presentation point of the playitem reaches a value referred to by the presentation time stamp information, the presentation of the associated subplayitem is begun. Thus, reproduction of the secondary video through one sub path is begun at a time during the reproduction of the primary video.

In this case, the playitem and subplayitem refer to different clips, respectively, because the secondary video is multiplexed in a stream different from that of the primary video. Each of the playitems and subplayitems includes information as to the reproduction start time IN-Time and reproduction end time OUT-Time of a particular clip to be reproduced. Accordingly, the clip referred to by the associated playitem and subplayitem is supplied to the AV decoder 17b.

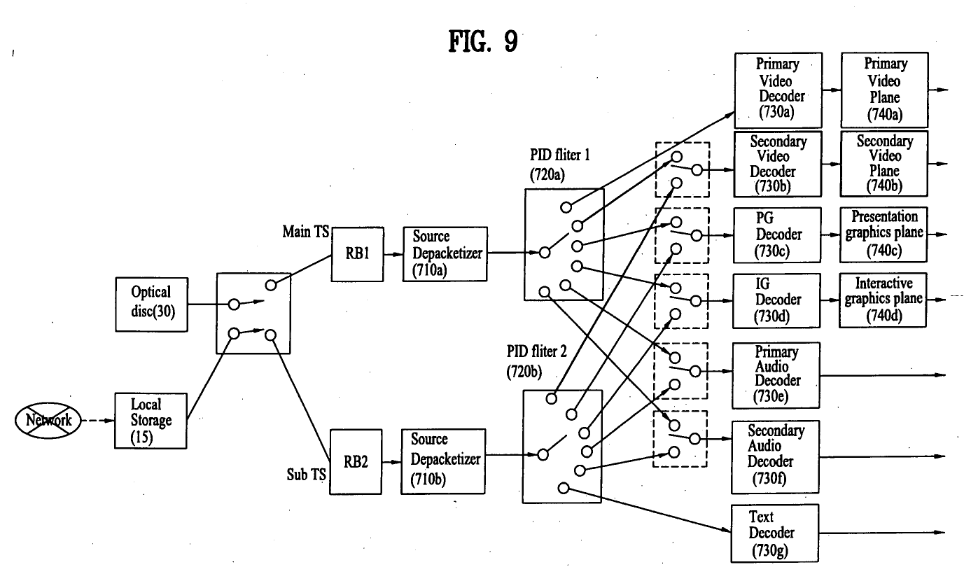

Referring to FIG. 9A schematically illustrating an AV decoder model according to the present invention, the stream file of the above-described clip is supplied to the AV decoder 17b in the form of a transport stream (TS). In the present invention, the AV stream, which is reproduced through a main path, is referred to as a main transport stream (hereinafter, referred to as a “main stream”), and an AV stream other than the main stream is referred to as a sub transport stream (hereinafter, referred to as a “sub stream”). Thus, the primary and secondary videos are supplied to the AV decoder 17b as a main stream and a sub stream, respectively. In the AV decoder 17b, a main stream from the optical disc 30 passes through a switching element to a buffer RB1, and the buffered main stream is depacketized by a source depacketizer 710a. Data contained in the depacketized AV stream is supplied to an associated one of decoders 730a to 730g after being separated from the depacketized AV stream in a PID (packet identifier) filter-1 720a in accordance with the kind of the data packet. As shown, the packets from the PID filter-1 720a may pass through another switching element before receipt by the decoders 730b-730g.

On the other hand, each sub stream from the optical disc 30 or local storage 15 passes through a switching element to a buffer RB2, the buffered sub stream is depacketized by a source depacketizer 710b. Data contained in the depacketized AV stream is supplied to an associated one of the decoders 730a to 730g after being separated from the depacketized AV stream in a PID filter-2 720b in accordance with the kind of the data packet. As shown, the packets from the PID filter-2 720b may pass through another switching element before receipt by the decoders 730b-730f.

That is, the primary video is decoded in a primary video decoder 730a, and the primary audio is decoded in a primary audio decoder 730e. Also, the PG (presentation graphics), IG (interactive graphics), secondary audio, text subtitle are decoded in a PG decoder 730c, an IG decoder 730d, a secondary audio decoder 730f, and a text decoder 730g, respectively.

The decoded primary video, secondary video, PG, and IG are reproduced by a primary video plane 740a, a secondary video plane 730b, a presentation graphics plane 740c, and an interactive graphics plane 740d, respectively. The presentation graphics plane 740c can also reproduce graphic data decoded in the text decoder 730g. The decoded primary and secondary audios are output after being mixed in an audio mixer. Since the sub path used to reproduce the secondary video is synchronous with the main path in the sub path type of FIG. 8A, the controller 12 performs a control operation for outputting the secondary video synchronously with the primary video in this case.

In the sub path type of FIG. 8A, in case that the primary video is reproduced in a trick playing mode, the secondary video may be reproduced synchronously with the trick playing of the primary video, similar to the above-described case.

In accordance with an embodiment of the present invention, the controller 12 determines from a trick playing flag whether or not the reproduced secondary video is to be displayed during the trick playing mode; namely, whether the secondary video window is to be closed. The content provider sets the trick playing flag to a value that instructs whether or not the secondary video window is to be closed during trick play of the primary video. If the content provider desires the secondary video window to be closed during trick playing of the primary video, the content provider may set the trick playing flag to a value of, for example, ‘0_{b}’. If the trick playing flag is set to a value of, for example, ‘0_{b}’, the optical recording/reproducing apparatus 10 closes the secondary video window in the trick playing mode of the primary video.

On the other hand, if the trick playing flag is set to a value (for example, ‘1b’) other than the close indicating value, the optical recording/reproducing apparatus 10 may maintain the secondary video window in an open state, or close the secondary video window. This may be optionally implemented in the optical recording/reproducing apparatus 10. Thus, the optical recording/reproducing apparatus 10 can close the secondary video window even in case that the trick playing flag has a value of ‘1b’. Under the condition in which the secondary video window is maintained in an open state, the secondary video is displayed synchronously with the trick playing of the primary video. For example, in case that the primary video is forwardly reproduced at double speed, the secondary video is also forwardly reproduced at double speed. On the other hand, in case that the primary video is backwardly reproduced, the secondary video is also backwardly reproduced at the same speed as that of the primary video. Thus, the secondary video reproduced in the above-described manner is provided to the user. Furthermore, if the secondary video is closed, the secondary video decoder 730b may continue to decode the secondary video, but the controller 12 prohibits the secondary video plane 740b from being displayed. In this manner, the secondary video may remain synchronous with the primary video.

The trick playing flag may be included in PiP metadata. Referring to FIG. 7, the content provider may provide a trick playing flag field (for example, ‘trick_playing_flag’ 910a), and may set ‘trick_playing_flag’ 910a to ‘0b’ or ‘1b’, to indicate whether or not the secondary video window should be closed during a trick playing mode of the primary video.

In a sub path type shown in FIG. 8B, the secondary video is encoded in a stream different from that of the primary video, and the sub path is asynchronous with the main path. Similar to the sub path type of FIG. 8A, the secondary video streams, which will be reproduced through sub paths, are multiplexed separate from a clip to be reproduced based on the associated playitem. However, the sub path type of FIG. 8B is different from the sub path type of FIG. 8A in that the presentation of the sub path can begin at any time on the timeline of the main path. Once the sub path presentation is started, the sub path presentation is then synchronized with the main path.

Referring to FIG. 8B, the playlist for managing the primary and secondary videos includes one main path used to reproduce the primary video, and one sub path used to reproduce the secondary video. The main path is configured by three playitems (‘PlayItem_id’=0, 1, 2), whereas the sub path is configured by one subplayitem. The secondary video, which is reproduced through the sub path, is asynchronous with the main path. That is, even in case that the subplayitem includes information for identifying a playitem associated with the subplayitem, and presentation time stamp information indicating a presentation time of the subplayitem in the playitem, this information is invalid in the sub path type of FIG. 8B. Accordingly, the optical recording/reproducing apparatus 10 can operate irrespective of the above-described information used to synchronize the main path and sub path. Thus, the user can view the secondary video at any time during the reproduction of the primary video.

In case that the sub path used to reproduce the secondary video corresponds to the sub path type of FIG. 8B, a reproduction of the secondary video can be started at any time, irrespective of the primary video, because it is unnecessary to reproduce the secondary video synchronously with the primary video. However, the secondary video is reproduced according to the trick playing of the primary video, even in case that the trick playing flag according to the present invention is set to a value indicating to close the secondary video window. It is the reason that once the sub path started its presentation, the sub path presentation is synchronized with the main path. Of course, it is also possible to close the secondary video window irrespective of the trick playing flag. If the secondary video window is closed, the secondary video may continue to be decoded, but not displayed, as discussed above.

In a sub path type shown in FIG. 8C, the secondary video is encoded in the same stream as the primary video, and the sub path is synchronous with the main path. The case in which the secondary video is multiplexed in a stream different from that of the primary video, as described above, is referred to as an ‘out-of-mux’ type. The sub path type of FIG. 8C is different from those of FIGS. 8A and 8B in that the secondary video is multiplexed in the same AV stream as the primary video. The case in which the secondary video is multiplexed in the same stream as the primary video, as described above, is referred to as an ‘in-mux’ type.

Referring to FIG. 8C, the playlist for managing the primary and secondary videos includes one main path and one sub path. The main path is configured by four playitems (‘PlayItem_id’=0, 1, 2, 3), whereas the sub path is configured by a plurality of subplayitems. Each of the subplayitems configuring the sub path includes information for identifying a playitem associated with the subplayitem, and presentation time stamp information indicating a presentation time of the subplayitem in the playitem. As described above with reference to FIG. 8A, each subplayitem is synchronized with the associated playitem, using the above-described information. Thus, the secondary video is synchronized with the primary video.

In the sub path type of FIG. 8C, each of the playitems configuring the main path and an associated one or ones of the subplayitems configuring the sub path refer to the same clip. Accordingly, the secondary video is provided to the AV decoder 17b, along with the primary video, as a main stream. As shown in FIG. 9, the main stream, which is packetized data including the primary and secondary videos, is depacketized by the source depacketizer 710a, and is then sent to the PID filter-1 720a. Data packets are separated from the depacketized data in the PID filter-1 720a in accordance with associated PIDs, respectively, and are then sent to associated ones of the decoders 730a to 730g, so as to be decoded. That is, the primary video is output from the primary video decoder 730a after being decoded in the primary video decoder 730a. The secondary video is output from the secondary video decoder 730b after being decoded in the secondary video decoder 730b. In this case, the controller 12 performs a control operation for displaying the secondary video synchronously with the primary video.

In case that the sub path used to reproduce the secondary video corresponds to the sub path type of FIG. 8C, the secondary video is reproduced synchronously with trick playing of the primary video, similarly to the case of FIG. 8A. As described above with reference to FIG. 8A, it is possible to determine, using the trick playing flag, whether or not the secondary video window, to which the secondary video is output, should be closed. If the secondary video window is closed, the secondary video may continue to be decoded, but not displayed, as discussed above.

The main stream and sub stream may be provided from the recording medium 30 or storage 15 to the AV decoder 17b. Where the primary and secondary videos are stored in different clips, respectively, the primary video may be recorded in the recording medium 30, to be provided to the user, and the secondary video may be downloaded from the outside of the recording medium 30 to the storage 15. Of course, the case opposite to the above-described case may be possible. However, where both the primary and secondary videos are stored in the recording medium 30, one of the primary and secondary videos may be copied to the storage 15, prior to the reproduction thereof, in order to enable the primary and secondary videos to be simultaneously reproduced. Where both the primary and secondary videos are stored in the same clip, they are provided after being recorded in the recording medium 30. In this case, however, it is possible that both the primary and secondary videos are downloaded from the outside of the recording medium 30.

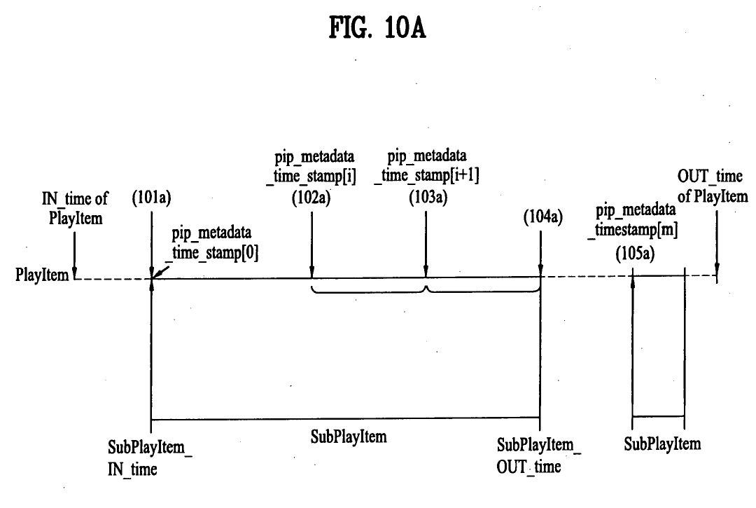

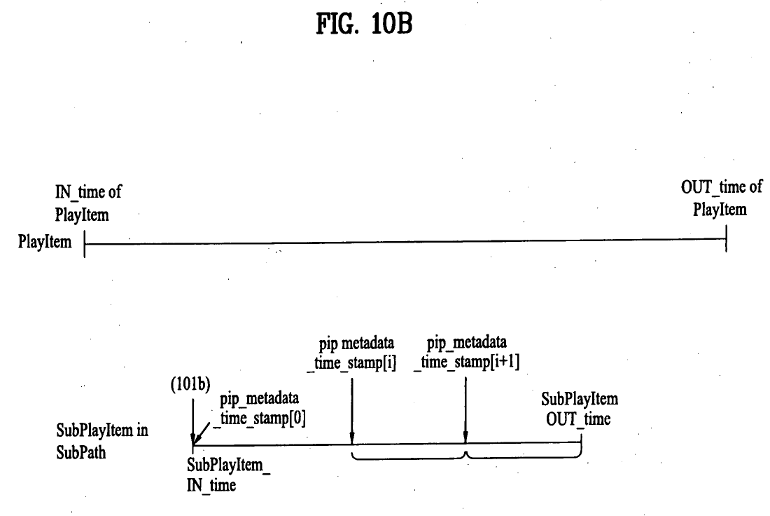

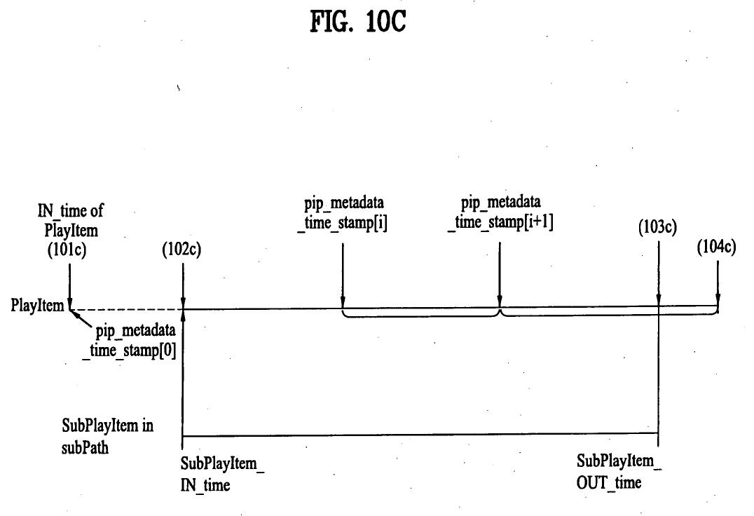

Referring to FIG. 7, the block header 910 may also include information indicating a timeline referred to by the associated Pip metadata (hereinafter, referred to as ‘pip_timeline_type’). The type of the secondary video provided to the user is varied depending on the PiP timeline type. Hereinafter, PiP timeline types according to embodiments of the present invention will be described with reference to FIGS. 10A to 10C.

FIGS. 10A to 10C are schematic diagrams for understanding of secondary video timeline types according to the present invention.

The block data 920 may include time stamp information indicating a point where PiP metadata is placed (hereinafter, ‘pip_metadata_time_stamp’). The ‘pip_timeline_type[k]’ is determined in accordance with the type of the timeline referred to by the entries of the above-described ‘pip_metadata_time_stamp[i]’, namely, the type of the timeline referred to by PiP metadata. Hereinafter, PiP timeline types will be described in detail with reference to ‘pip_timeline_type[k]’ and ‘pip_metadata_time_stamp[i]’.

In the PiP timeline type of FIG. 10A, the sub path used to reproduce the secondary video is synchronous with the main path, and the entries of ‘pip_metadata_time_stamp’ refer to the timeline of the playitem referred to by PiP metadata. In FIG. 10A, ‘pip_metadata_time_stamp’ indicates presentation times of the intervals of associated subplayitems which are projected on the timeline of the playitem referred to by ‘PlayItem_id[k]’. In the timeline type of FIG. 10A, ‘pip_metadata_time_stamp[O]’ and ‘pip_metadata_time_stamp[m]’ are put at the beginning points 101a and 105a of each of the intervals that the associated subplayitem intervals are projected on the timeline of the playitem referred to by ‘playitem_d[k]’, respectively.

The block data 920 includes at least one block of secondary video composition information (hereinafter, referred to as ‘pip_composition_metadata’), the number of which is determined in accordance with ‘pip_metadata_time_stamp[i]’. The i-th ‘pip_composition_metadata’ is secondary video composition information which is valid between ‘pip_metadata_time_stamp[i]’ 102a and ‘pip_metadata_time_stamp[i+1]’ 103a. The last ‘pip_composition_metadata’ in one block data 920 is valid until the presentation end time 104a of the sub path indicated by ‘secondary_video_stream_id[k]’ included in the PiP metadata.

The secondary video composition information is information indicating the reproduction position and size of the secondary video. The secondary video composition information may include position information of the secondary video, and size information of the secondary video (hereinafter, referred to as ‘pip_scale[i]’). The position information of the secondary video includes horizontal position information of the secondary video (hereinafter, referred to as ‘pip_horizontal_position[i]’), and vertical position information of the secondary video (hereinafter, referred to as ‘pip_vertical_position[i]’). The information ‘pip_horizontal_position’ indicates a horizontal position of the secondary video displayed on a screen if viewing from an origin of the screen, and the information ‘pip_vertical_position’ indicates a vertical position of the secondary video displayed on the screen if viewing from the origin of the screen. The display size and position of the secondary video on the screen are determined by the size information and position information.

In the timeline type of FIG. 10A, the sub path indicated by the above-described ‘secondary_video_stream_id[k]’ corresponds to the sub path type 810 or 830 described with reference to FIG. 8A or 8C because the sub path used to reproduce the secondary video, namely, the PiP presentation path, is synchronous with the main path. In a trick playing mode of the primary video, accordingly, the secondary video is reproduced synchronously with the trick playing of the primary video. Of course, the optical recording/reproducing apparatus 10 closes the secondary video window, to which the secondary video is output, or maintains the secondary video in an open state, in accordance with the trick playing flag.

In the timeline type of FIG. 10A, the secondary video refers to the timeline of the main path because the secondary video is reproduced synchronously with the playitems presented through the main path. That is, in case that the presentation point of the main path used to reproduce the primary video is positioned, for example, between ‘pip_metadata_time_stamp [i]’ and ‘pip_metadata_time_stamp[i+1]’ in a trick playing mode of the primary video, ‘pip_composition_metadata[i]’ corresponding to ‘pip_metadata_time_stamp[i]’ is applied to the secondary video. Accordingly, the secondary video is displayed on the primary video.

FIG. 10B illustrates the case in which the PiP presentation path is asynchronous with the main path, and the timeline of the sub path is referred to by the entries of ‘pip_metadata_time_stamp’. In the embodiment of FIG. 10B, the sub path indicated by the above-described ‘secondary_video_time_stamp_id[k]’ should correspond to the sub path type described in conjunction with FIG. 8B because the PiP presentation path is asynchronous with the main path. In the timeline type of FIG. 10B, ‘pip_metadata_time_stamp’ indicates a presentation time in the interval of the subplayitem indicated by ‘secondary_video_stream_id[k]’ included in the PiP metadata. In this timeline type, ‘pip_metadata_time_stamp[0]’ may be put at the beginning point 101b of the subplayitem.

In the timeline type of FIG. 10B, the secondary video is reproduced through the sub path, irrespective of the reproduction procedure through the main path, because the secondary video follows the timeline of the subplayitem. That is, the timeline type of FIG. 10B is different from the timeline type of FIG. 10A in that, even in case that the presentation point of the main path is changed to a certain point on the timeline of the playitem reproduced through the main path, the secondary video is reproduced irrespective of the change. For example, the presentation position and scale of the secondary video do not change.

In the timeline type of FIG. 10B, the PiP presentation path is asynchronous with the main path, as described above. Accordingly, the sub path indicated by the above-described ‘secondary_video_time_stamp_id[k]’ should correspond to the sub path type described in conjunction with FIG. 8B.

FIG. 10C illustrates the case in which the PiP presentation path is asynchronous with the main path, and the timeline of the playitem referred to by ‘PlayItem_id[k]’ included in the PiP metadata is referred to by the entries of ‘pip_metadata_time_stamp’. Similar to the timeline type of FIG. 10A, the timeline of the playitem is referred to in the timeline type of FIG. 10C. Accordingly, ‘SubPlayItem_IN_time’ is projected on the timeline of the playitem at a point 102c. In the timeline type of FIG. 10C, ‘pip_metadata_time_stamp’ indicates a presentation time in the interval of the playitem indicated by ‘PlayItem_id[k]’. In the timeline type of FIG. 10C, ‘pip_metadata_time_stamp[0]’ may be put at the beginning point 101c of the interval of the playitem indicated by ‘PlayItem_id[k]’ because the PiP metadata refers to the timeline of the playitem indicated by ‘PlayItem_id[k]’. However, in the case of the timeline type of FIG. 10A, ‘pip_metadata_time_stamp[0]’ is put at the beginning point 101a of the interval that the associated subplayitem interval is projected on the timeline of the playitem referred to by the ‘playitem_id[k]’.

In the timeline type of FIG. 10C, the secondary video can be started, irrespective of the primary video, differently from the timeline type of FIG. 10A, because the sub path used to reproduce the secondary video is asynchronous with the main path. During the trick playing of the primary video, ‘pip_composition_metadata’ corresponding to the presentation point of the main path is applied to the secondary video because the PiP metadata refers to the timeline of the associated playitem. Referring to FIG. 10C, it can be seen that, for example, in case that the presentation position of the main path moves back from the position of ‘pip_metadata_time_stamp[i+1]’ to the position of ‘pip_metadata_time_stamp[i]’ in accordance with a backward playing mode under the condition in which ‘pip_composition_metadata[i+1]’ corresponding to ‘pip_metadata_time_stamp[i+1]’ is applied to the secondary video, ‘pip_composition_metadata[i]’ corresponding to ‘pip_metadata_time_stamp[i]’ is applied to the secondary video. Accordingly, the reproduction path and speed of the secondary video, and the size and position of the secondary video window, to which the secondary video is output, are influenced by the trick playing of the primary video. Thus, although the reproduction of the streams of the secondary video is continued even during the trick playing of the primary video, the reproduction path and speed, and the size and position of the secondary video viewed by the user are varied in accordance with the trick playing of the primary video.

In the timeline type of FIG. 10C, the sub path indicated by the above-described ‘secondary_video_time_stamp_id[k]’ should correspond to the sub path type described in conjunction with FIG. 8B because the Pip presentation path is asynchronous with the main path.

In the timeline type of FIG. 10C, ‘pip_metadata_time_stamp[i+1]’ is valid until the out time 104c of the current playitem because PiP metadata indicates the presentation time in the interval of the playitem referred to by ‘PlayItem_id[k]’. After the subplayitem out time 103c, however, the secondary video is no longer displayed because the last ‘pip_composition_metadata’ in one block data 920 is valid until the presentation end time of the sub path indicated by ‘secondary_video_stream_id[k]’.

The present invention relates to a data reproducing method for reproducing a secondary video in a trick playing mode of a primary video, using a trick playing flag. The content provider provides the trick playing flag to the user by storing the trick playing flag in the database area of data in case that the data is provided via a recording medium or a network. The optical recording/reproducing apparatus 10 of the present invention checks the trick playing flag stored in the database area. Based on the identified trick playing flag, the optical recording/reproducing apparatus 10 closes the secondary video window in a trick playing mode of the primary video in case that the trick playing flag is set to a value (for example, ‘0b’) indicating to close the secondary video window. On the other hand, in case that the trick playing flag is set to a value (for example, ‘1b’) other than the close value, the optical recording/reproducing apparatus 10 may maintain the secondary video window in an open state, or may close the secondary video window.

In the timeline type in which the secondary video is asynchronous with the primary video, the secondary video can be reproduced through an original reproduction path thereof irrespective of the trick playing of the primary video. Accordingly, the trick playing flag may be valid in the timeline type in which the secondary video is synchronous with the primary video, namely, in the case in which the sub path used to reproduce the secondary video corresponds to the sub path type of FIG. 8A or 8C.

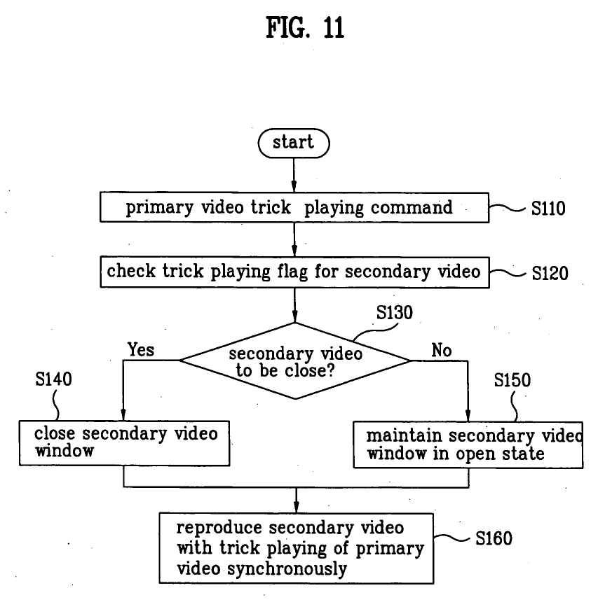

FIG. 11 is a flow chart illustrating a data reproducing method according to an embodiment of the present invention.

If a trick playing command for the primary video is generated (e.g., by user input) during reproduction of data stored in the recording medium and/or storage (S110), the primary video is reproduced in accordance with the trick playing command. The controller 12 checks the trick playing flag for the secondary video (S120), to determine whether or not to close the reproduced secondary video window (S130).

In accordance with an embodiment of the present invention, if the trick playing flag is set to a close value, the secondary video window is closed assuming the trick playing of the primary video is begun in a state where the secondary video window is open (S140). However, if the trick playing of the primary video is begun in a state where the secondary video is closed, the secondary video window is not opened even if the display time point for beginning display of the secondary video is reached. On the other hand, if that the trick playing flag is set to a value other than the close value, the secondary video window may be closed (S140), or may be opened (S150), in accordance with an option implemented in the optical recording/reproducing apparatus 10.

For the sub path type where the secondary video is asynchronous with the primary video, the secondary video can be normally started irrespective of the primary video. In this case, the controller 12 may not change a state of the secondary video window based on the trick playing flag. That is, even in case that the trick playing flag is set to a value indicating to close the secondary video window, the controller 12 may not close the secondary video window. Of course, the controller 12 may close the secondary video window. The secondary video is reproduced synchronously with the primary video. On the other hand, where the secondary video is synchronous with the primary video, the secondary video is reproduced synchronously with the primary video (S160). Even if the secondary video window is closed, the secondary video should be synchronized with the primary video. For example, even though not displayed, the secondary video window may continue to be decoded, only the decoded output is not provided to the user. After completion of the trick playing of the primary video, the secondary video window may be opened.

In accordance with embodiments of the present invention, it is possible to reproduce the secondary video along with the primary video, even in the trick playing mode of the primary video. The content provider can set whether or not the secondary video reproduced in the trick playing mode of the primary video should be provided to the user, using the trick playing flag for the secondary video. Accordingly, there are advantages in that it is possible to validly reproduce the secondary video along with the primary video, and to implement more diverse secondary video.

As apparent from the above description, in accordance with the recording medium, data reproducing method and apparatus, and data recording method and apparatus of the present invention, it is possible to reproduce the secondary video along with the primary video even in the trick playing mode of the primary video. In addition, it is possible to control whether or not the secondary video reproduced in the trick playing mode of the primary video should be provided to the user. Accordingly, there are advantages in that the content provider can compose more diverse contents, to enable the user to experience more diverse contents.

It will be apparent to those skilled in the art that various modifications and variations can be made in the present invention without departing from the spirit or scope of the inventions. Thus, it is intended that the present invention covers the modifications and variations of this invention.

What is claimed is:

1. A method of managing reproduction of at least one picture-in-picture presentation path, comprising:
reading management data from a recording medium;
selectively displaying a secondary video stream with a primary video stream based on the management data, the secondary video stream representing the picture-in-picture presentation path with respect to a primary presentation path represented by the primary video stream; and
decoding the secondary video stream even if the selectively displaying step does not display the secondary video stream.

2. The method of claim 1, wherein
the management data includes display information indicating whether to close a window in which the secondary video stream is to be displayed; and
the selectively displaying step displays the secondary video stream based on the display information.

3. The method of claim 2, wherein the display information indicates whether to close the window in which the secondary video stream is to be displayed during trick play of the primary video stream.

4. The method of claim 3, wherein the selectively displaying step selectively displays the secondary video stream based on the display information only if the secondary video stream is being reproduced synchronously with the primary video stream.

5. The method of claim 3, wherein the reading step reads metadata from a playlist recorded on the recording medium, the playlist indicating at least one playitem to reproduce, the playitem indicating a playing interval of the primary video stream, and the metadata including the management data.

6. The method of claim 5, wherein
the metadata includes composition information indicating a position to display the secondary video stream window; and
the selectively displaying step displays the secondary video stream window at the position indicated by the composition information.

7. The method of claim 6, wherein
the composition information indicates a size to display the secondary video stream window; and
the selectively displaying step displays the secondary video stream window at the size indicated by the composition information.

8. The method of claim 5, wherein
the composition information indicates a size to display the secondary video stream window; and
the selectively displaying step displays the secondary video stream window at the size indicated by the composition information.

9. The method of claim 1, wherein the reading step reads metadata from a playlist recorded on the recording medium, the playlist indicating at least one playitem to reproduce, the playitem indicating a playing interval of the primary video stream, and the metadata including the management data.

10. The method of claim 9, wherein
the metadata includes composition information indicating a position to display the secondary video stream; and
the selectively displaying step displays the secondary video stream at the position indicated by the composition information.

11. The method of claim 10, wherein
the composition information indicates a size to display the secondary video stream; and
the selectively displaying step displays the secondary video stream at the size indicated by the composition information.

12. The method of claim 9, wherein
the metadata includes composition information indicating a size to display the secondary video stream; and
the selectively displaying step displays the secondary video stream at the size indicated by the composition information.

13. An apparatus for managing reproduction of at least one picture-in-picture presentation path, comprising:
a driver configured to drive a reproducing element for reproducing data from a recording medium;
a controller configured to control the driver to read management data from the recording medium;
the controller configured to selectively display a secondary video stream with a primary video stream based on the management data, the secondary video stream representing the picture-in-picture presentation path with respect to a primary presentation path represented by the primary video stream; and
a decoder configured to decode the secondary video stream even if the controller does not display the secondary video stream.

14. The apparatus of claim 13, wherein
the management data includes display information indicating whether to close a window in which the secondary video stream is to be displayed; and
the controller is configured to selectively display the secondary video stream based on the display information.

15. The apparatus of claim 14, wherein the display information indicates whether to close the window in which the secondary video stream is to be displayed during trick play of the primary video stream.

16. The apparatus of claim 15, wherein the controller is configured to selectively display the secondary video stream based on the display information only if the secondary video stream is being reproduced synchronously with the primary video stream.

17. The apparatus of claim 15, wherein the controller is configured to control the driver to read metadata from a playlist recorded on the recording medium, the playlist indicating at least one playitem to reproduce, the playitem indicating a playing interval of the primary video stream, and the metadata including the management data.

18. The apparatus of claim 17, wherein
the metadata includes composition information indicating a position to display the secondary video stream window; and
the controller is configured to display the secondary video stream window at the position indicated by the composition information.

19. The apparatus of claim 18, wherein
the composition information indicates a size to display the secondary video stream window; and
the controller is configured to display the secondary video stream window at the size indicated by the composition information.

20. The apparatus of claim 17, wherein
the metadata includes composition information indicating a size to display the secondary video stream window; and
the selectively displaying step displays the secondary video stream window at the size indicated by the composition information.

21. The apparatus of claim 13, wherein the controller is configured to control the driver to read metadata from a playlist recorded on the recording medium, the playlist indicating at least one playitem to reproduce, the playitem indicating a playing interval of the primary video stream, and the metadata including the management data.

22. A recording medium having a data structure for managing reproduction of at least one picture-in-picture presentation path, comprising:
a data area storing a primary video stream, the primary video stream representing a primary presentation path; and
a management area storing management data for managing reproduction of a picture-in-picture presentation path with respect to the primary presentation path, the management data including display information indicating whether to close a window in which a secondary video stream is to be displayed, the secondary video stream representing the picture-in-picture presentation path.

23. The recording medium of claim 22, wherein the display information indicates whether to close the window in which the secondary video stream is to be displayed during trick play of the primary video stream.

24. The recording medium of claim 22, wherein the management area stores a playlist indicating at least one playitem to reproduce, the playitem indicates a playing interval of the primary video stream, and the playlist includes metadata that includes the management data.

25. The recording medium of claim 24, wherein the metadata includes composition information indicating a position to display the secondary video stream window

26. The recording medium of claim 24, wherein the metadata includes composition information indicating a size to display the secondary video stream window.

27. The recording medium claim 22, wherein
the display information indicates whether to close the window in which the secondary video stream is to be displayed only if the secondary video stream is being reproduced synchronously with the primary video stream.

28. A method of recording a data structure for managing reproduction of at least one picture-in-picture presentation path on a recording medium, comprising:
storing a primary video stream in a data area of the recording medium, the primary video stream representing a primary presentation path; and
storing management data for managing reproduction of a picture-in-picture presentation path with respect to the primary presentation path in a management area of the recording medium, the management data including display information indicating whether to close a window in which a secondary video stream is to be displayed, the secondary video stream representing the picture-in-picture presentation path.

29. The method of claim 28, wherein the display information indicates whether to close the window in which the secondary video stream is to be displayed during trick play of the primary video stream.

30. The method of claim 28, wherein the storing management data step stores a playlist in the management area, the playlist indicating at least one playitem to reproduce, the playitem indicates a playing interval of the primary video stream, and the playlist includes metadata that includes the management data.

31. The method of claim 30, wherein the metadata includes composition information indicating a position to display the secondary video stream window

32. The method of claim 30, wherein the metadata includes composition information indicating a size to display the secondary video stream window.

33. The method of claim 28, wherein
the display information is valid when the secondary video stream is being reproduced synchronously with the primary video stream.

34. An apparatus for recording a data structure for managing reproduction of at least one picture-in-picture presentation path on a recording medium, comprising:
a driver configure to drive a recording element for recording data on a recording medium; and
a controller configured to control the driver to store a primary video stream in a data area of the recording medium, the primary video stream representing a primary presentation path; and
the controller configured to control the driver to store management data for managing reproduction of a picture-in-picture presentation path with respect to the primary presentation path in a management area of the recording medium, the management data including display information indicating whether to close a window in which a secondary video stream is to be displayed, the secondary video stream representing the picture-in-picture presentation path.

35. The apparatus of claim 34, wherein the display information indicates whether to close the window in which the secondary video stream is to be displayed during trick play of the primary video stream.

36. The apparatus of claim 34, wherein the controller is configured to control the driver to store a playlist in the management area, the playlist indicating at least one playitem to reproduce, the playitem indicates a playing interval of the primary video stream, and the playlist includes metadata that includes the management data.

37. The apparatus of claim 36, wherein the metadata includes composition information indicating a position to display the secondary video stream window

38. The apparatus of claim 36, wherein the metadata includes composition information indicating a size to display the secondary video stream window.

39. The apparatus of claim 34, wherein
the display information indicates whether to close the window in which the secondary video stream is to be displayed only if the secondary video stream is being reproduced synchronously with the primary video stream.
